(19) United States
(12) Patent Application Publication
(10) Pub. No.: US 2017/0099350 A1
(43) Pub. Date: Apr. 6, 2017

(54) APPARATUS AND METHOD FOR TRANSMITTING MASS DATA

(71) Applicant: TOBESOFT CO., LTD, Seoul (KR)

(72) Inventors: Hwajun SONG, Seoul (KR); Woocheol LEE, Seoul (KR)

(73) Assignee: TOBESOFT CO., LTD, Seoul (KR)

(21) Appl. No.: 15/259,067

(22) Filed: Sep. 8, 2016

(30) Foreign Application Priority Data
Oct. 5, 2015 (KR) 10-2015-0139670

(51) Int. Cl. H04L 29/08; H04L 12/927

(52) U.S. Cl. CPC H04L 67/1095; H04L 67/02; H04L 47/808

(57) ABSTRACT

A method and apparatus for transmitting mass data includes receiving data transmission request information from a client, for data transmission by a transceiver of a Web Application Server (WAS), determining a size of data requested by the client from a database storing the data based on the data transmission request information by a data checker of the WAS, sequentially reading data of a predetermined size out of the whole data to be transmitted according to the size of the whole data and storing the read data in a memory of the WAS by a data extractor of the WAS, sequentially converting the read data to a predetermined data format by a data converter of the WAS, sequentially transmitting the converted data to the client by a transceiver of the WAS, and deleting the completely transmitted data from the memory of the WAS by a data deleter of the WAS.

### CROSS REFERENCE TO PRIOR APPLICATIONS

This application claims the benefit of Korean Patent Application No. 10-2015-0139670 filed on Oct. 5, 2015, which is hereby incorporated by reference in its entirety.

### BACKGROUND

The present invention relates to an apparatus and method for transmitting mass data, and more particularly, to a method for processing mass data transmission in a Web environment.

In general, data communication is conducted by determining a format, combining data content, and transmitting the combined data content in the determined format.

Among data communication schemes, eXtensible Markup Language (XML) requires a capacity larger than the amount of pure data by three or more times, because it is based on tags.

Another data communication scheme, Java Script Object Notation (JSON) needs to add object information to transmit data. Both XML and JSON impose a constraint that the start and end of data should be determined.

Another data communication scheme, Comma-Separated Values (CSV) uses a comma “,” or a “\n” value as a data delimiter. Because the data delimiter is meaningful as a value, double quotation marks should be added before and after pure data during data conversion. As a result, the size of data is increased during the data conversion.

### SUMMARY

Accordingly, the present invention is directed to an apparatus and method for transmitting mass data that substantially obviate one or more problems due to limitations and disadvantages of the related art.

An object of the present invention is to provide a mass data transmission apparatus and method for efficiently transmitting mass data, while minimizing memory use of a Web Application Server (WAS) by segmenting data for transmission and reception between a client and the WAS.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for transmitting mass data includes receiving data transmission request information from a client, for data transmission by a transceiver of a Web Application Server (WAS), determining a size of data requested by the client from a database storing the data based on the data transmission request information by a data checker of the WAS,
sequentially reading data of a predetermined size out of the whole data to be transmitted according to the size of the whole data and storing the read data in a memory of the WAS by a data extractor of the WAS, sequentially converting the read data to a predetermined data format by a data converter of the WAS, sequentially transmitting the converted data to the client by a transceiver of the WAS, and deleting the completely transmitted data from the memory of the WAS by a data deleter of the WAS. At least one of American Standard Code for Information Interchange (ASCII) code decimal numbers 1 to 31 is used as a data delimiter in the data format.

The data format may include a plurality of records corresponding to the predetermined size, and the plurality of records and data included in the plurality of records may be distinguished from each other by the data delimiter.

A unit separator being the ASCII code decimal number 31 may be used as the data delimiter to distinguish data from each other in the same record in the data format.

A record separator being the ASCII code decimal number 30 may be used as the data delimiter to distinguish records from each other in the same record in the data format.

In another aspect of the present invention, an apparatus for transmitting mass data includes a transceiver for transmitting and receiving data, a memory for storing the data, a data checker for determining a size of the data from a database storing the data based on data transmission request information received from a client by the transceiver, a data extractor for sequentially reading data of a predetermined size out of the whole data to be transmitted according to the size of the whole data and storing the read data in the memory, a data converter for sequentially converting the read data to a predetermined data format, and a data deleter for, upon completion of transmission of the converted data, deleting the data from the memory. At least one of ASCII code decimal numbers 1 to 31 is used as a data delimiter in the data format.

The data format may include a plurality of records corresponding to the predetermined size, and the plurality of records and data included in the plurality of records are distinguished from each other by the data delimiter.

A unit separator being the ASCII code decimal number 31 may be used as the data delimiter to distinguish data from each other in the same record in the data format.

A record separator being the ASCII code decimal number 30 may be used as the data delimiter to distinguish records from each other in the same record in the data format.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an overall system for performing a mass data transmission method according to an embodiment of the present invention;

FIG. 2 is a block diagram of a mass data transmission apparatus (Web Application Server (WAS)) according to an embodiment of the present invention;

FIG. 3 is a flowchart illustrating a mass data transmission method according to an embodiment of the present invention;

FIG. 4 illustrates an exemplary data format in the mass data transmission method according to an embodiment of the present invention; and

FIG. 5 illustrates another exemplary data format in the mass data transmission method according to an embodiment of the present invention.

### DETAILED DESCRIPTION

Objects, advantages, and technical structures for achieving them will become apparent upon examination of the following detailed description of embodiments of the present invention as well as the attached drawings. In the description of the present invention, a detailed description of known functions or configurations will be omitted lest it should obscure the subject matter of the present invention. The terms as set forth herein are defined in consideration of the structures, roles, and functions of the present invention, and may vary according to the intent of a user and an operator, or customs.

However, the present invention is not limited to the disclosed embodiments. Rather, the present invention may be implemented in various other ways. The embodiments are provided to make the disclosure of the present invention comprehensive and help those skilled in the art to comprehensively understand the scope of the present invention, and the present invention is defined only by the appended claims. Therefore, the definition should be made based on the overall contents of the specification.

If it is said that a part “includes” a component, this means that any other component may further be included, not excluding another component, unless otherwise specified.

With reference to the attached drawings, preferred embodiments of the present invention will be described in great detail.

Meanwhile, each component, function block, or means may be comprises of one or more sub-components in the embodiments of the present invention. Electrical, electronic, and mechanical functions performed by each component may be executed by various known devices or mechanical elements such as electronic circuits, Integrated Circuits (ICs), or Application Specific Integrated Circuits (ASICs). The device or elements may be implemented separately or two or more devices or elements may be incorporated into one unit.

Further, blocks of a flowchart and a combination of steps in flowcharts may be executed by computer program instructions. These computer program instructions may be loaded on a processor of programmable data processing equipment such as a general purpose computer, a special purpose computer, a portable laptop computer, and a network computer. When the loaded program instructions are executed by the processor, they create means for carrying out functions described in the block diagrams or the flowcharts. As the computer program instructions may be stored in a memory usable in a specialized computer or a programmable data processing equipment, or a computer readable memory, it is also possible to create articles of manufacture that carry out functions described in the block diagrams or the flowcharts. As the computer program instructions may be loaded on a computer or a programmable data processing equipment, when executed as processes, they may carry out steps of functions described in the block diagrams or the flowcharts.

Each block or each step may correspond to a module, a segment or a code containing one or more executable instructions implementing one or more specified logical functions, or to a part thereof. It is to be noted that in alternative embodiments, it is also possible to execute functions described in blocks or steps in an order different from the listed order. For example, two blocks or steps listed in sequence may be executed substantially at the same time or executed in reverse order according to corresponding functions when needed.

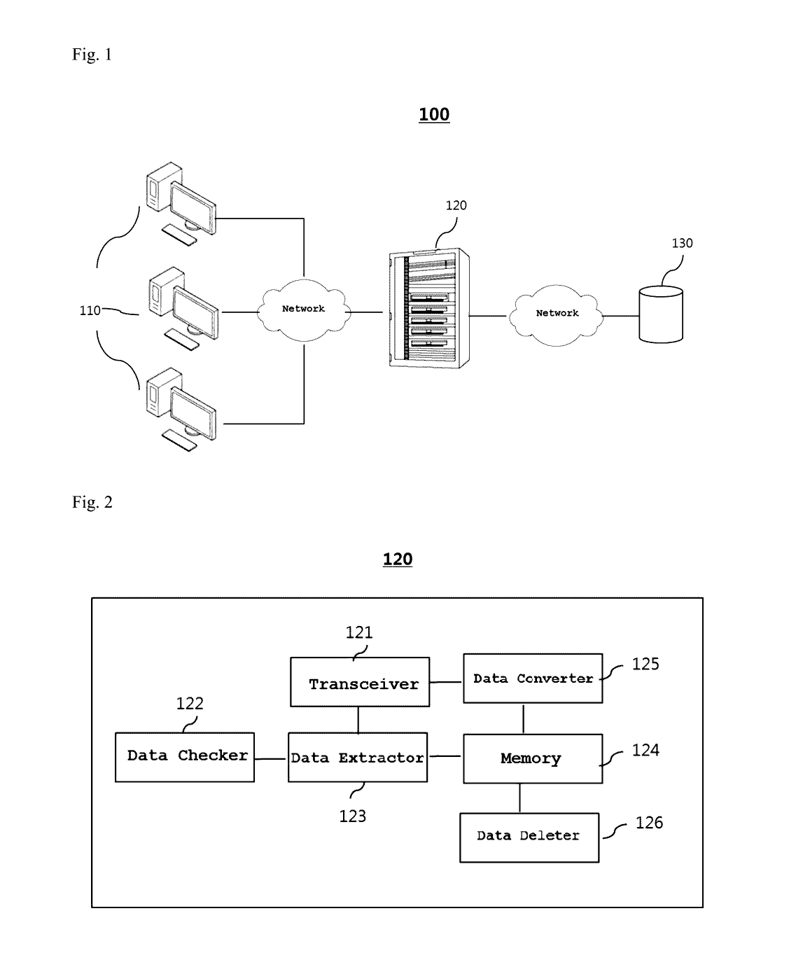

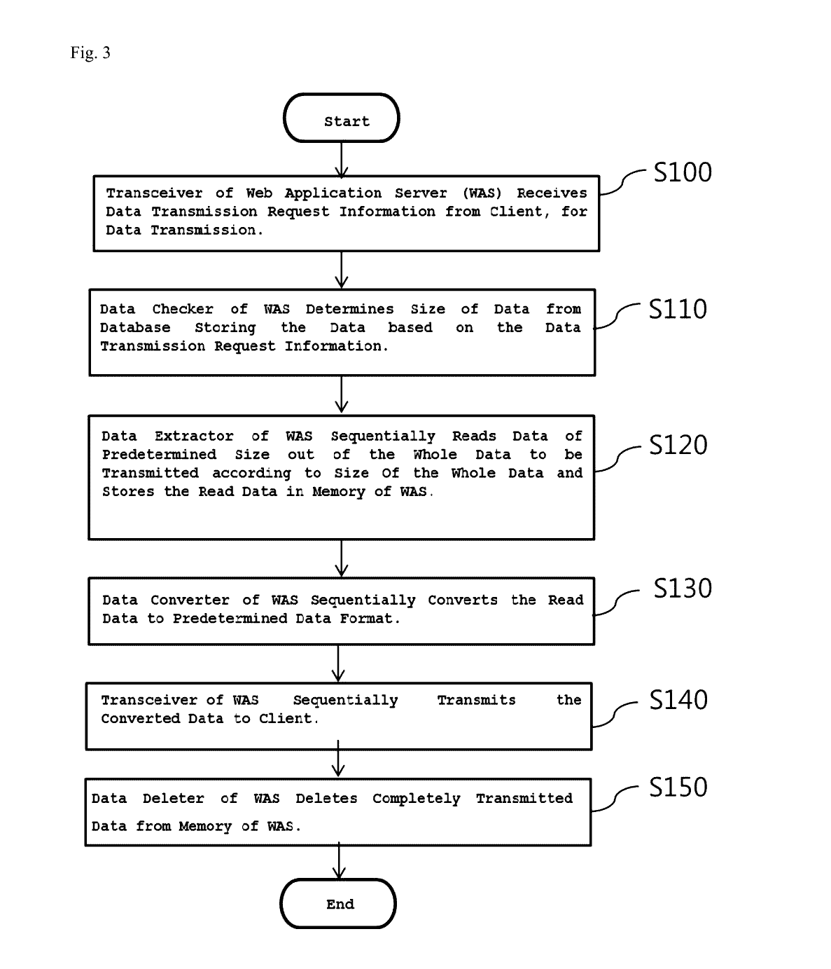

FIG. 1 is a view illustrating an overall system for performing a mass data transmission method according to an embodiment of the present invention, FIG. 2 is a block diagram of a mass data transmission apparatus (or Web Application Server (WAS)) according to an embodiment of the present invention, and FIG. 3 is a flowchart illustrating a mass data transmission method according to an embodiment of the present invention.

Referring to FIG. 1, a system 100 includes clients 110, a WAS 120, and a DataBase (DB) 130. The clients 110 and the WAS 120 are connected to each other through a network, and the WAS 120 and the DB 130 are also connected to each other through a network.

A plurality of clients 110 may be connected to the WAS 120 through the network. If a client 110 requests specific data to the WAS 120, the WAS 120 reads the data from the DB 130 and transmits the data to the client 110.

The WAS 120 includes a transceiver 121, a data checker 122, a data extractor 123, a memory 124, a data converter 125, and a data deleter 126.

The transceiver 121 of the WAS 120 receives data transmission request information from a client 110, for data transmission (S100).

The data transmission request information includes information about data requested by the client 110. The WAS 120 may check data stored in the DB 130 based on the data transmission request information, and transmit data.

The data checker 122 performs a process of checking the size of the data from the DB 130 (S110).

In the case where the data requested by the client 110 is large in size, if the whole data read from the DB 130 is transmitted, the data occupies much of the memory 124 of the WAS 120, thereby degrading the processing performance of the WAS 120. Moreover, when the client 110 receives the data from the WAS 120, a longer time is taken to load the data, thus decreasing data transmission efficiency.

To increase the transmission efficiency of mass data, the data extractor 123 performs a process of reading data of a predetermined size in sequence out of the whole data to be transmitted, according to the size of the whole data, and storing the data in the memory 124 (S120).

The predetermined size may be set appropriately according to a specification of the WAS 120 and a state of the network.

Then, the data converter 125 performs a process of sequentially converting the data to a predetermined data format (S130).

The data format may include a plurality of records (corresponding to ROWs in the data format) corresponding to the predetermined size, and the plurality of records may be converted to the predetermined data format using data delimiters.

The data delimiters in the data format may be at least one of American Standard Code for Information Interchange (ASCII) code decimal numbers 1 to 31. The ASCII code decimal numbers 1 to 31 correspond to special characters.

Comma-Separated Values (CSV) uses a comma “,” or a “ \n” value as a data delimiter. Because the data delimiter is meaningful as a value, double quotation marks should be added before and after pure data during data conversion. As a result, the size of data is increased during the data conversion.

In contrast, since the ASCII code decimal numbers 1 to 31 correspond to special characters, there is no need for adding double quotation marks before and after pure data. In view of the use of these special characters as data delimiters, the increase of the total capacity of transmission data may be minimized during data conversion, for mass data transmission.

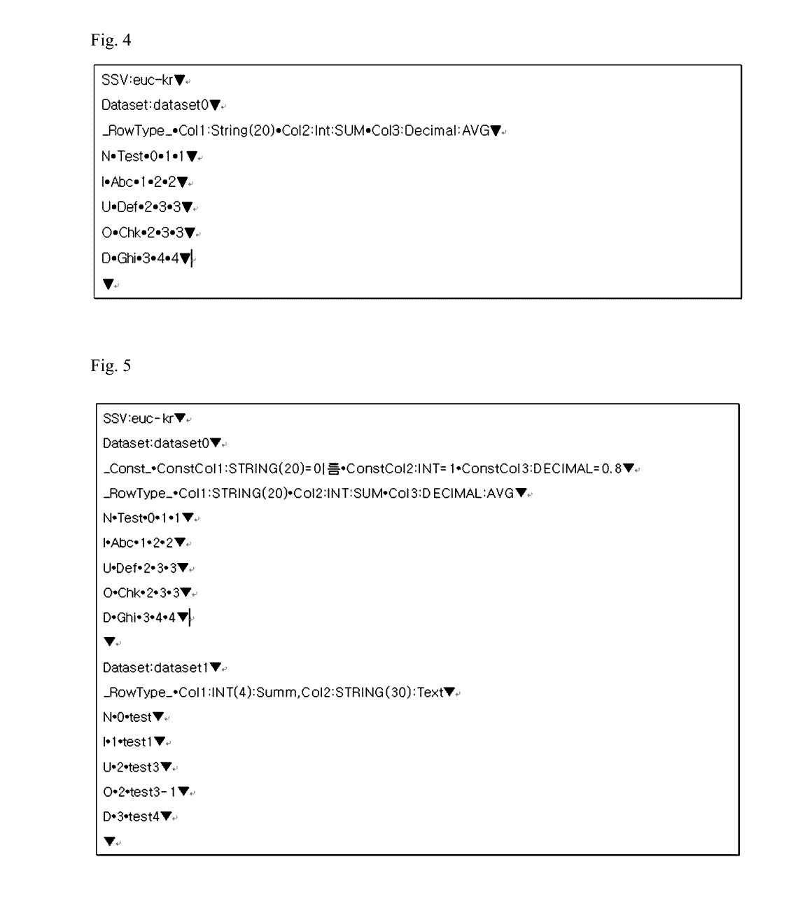

FIG. 4 illustrates an exemplary data format in the mass data transmission method according to an embodiment of the present invention, and FIG. 5 illustrates another exemplary data format in the mass data transmission method according to an embodiment of the present invention.

In FIGS. 4 and 5, it is assumed that “·” represents a unit separator being the ASCII code decimal number 31, and “▾” represents a record separator being the ASCII code decimal number 30.

As illustrated in FIGS. 4 and 5, the unit separator being the ASCII code decimal number 31 may be used as a data delimiter to make a distinction between data in the same record, and the record separator being the ASCII code decimal number 30 may be used as a data delimiter.

The specific data delimiters are purely exemplary, and a data delimiter may be appropriately selected from among the special characters, that is, the ASCII code decimal numbers 1 to 31.

Since a distinction is made between data and between records by means of special characters as described above, the increase of the total capacity of transmission data caused by a data delimiter during data conversion may be minimized.

Subsequently, the transceiver 121 transmits the converted data sequentially to the client 110 (S140).

The data deleter 126 deletes the completely transmitted data from the memory 124 (S150). As the completely transmitted data is deleted from the memory 124, the amount of data stored in the memory 124 may be minimized, thereby increasing the processing performance of the WAS 120.

When the WAS 120 transmits data to the client 110, the total size of data is the same in both cases where the data is transmitted at one time, and the data is transmitted in the mass data transmission method according to the embodiment of the present invention. However, in the case where data is transmitted in streams in a streaming scheme of the mass data transmission method according to the embodiment of the present invention, much less of the memory 124 of the WAS 120 is used than in the case where a whole message is transmitted at one time, from the start of the data transmission until the end of the data transmission.

For example, if a total of 1000 streams are transmitted, 100 streams each time in the stream scheme of the mass data transmission method according to the embodiment of the present invention, only a memory capacity corresponding to 100 streams is used in the WAS 100. That is, after 100 streams are transmitted, the data is deleted from the memory 124. Then, after the next 100 streams are transmitted, the data is also deleted from the memory 124. In this manner, the memory use may be minimized, thereby increasing the transmission efficiency of the WAS 120.

In the above method, the amount of used resources is minimized and thus it is possible to transmit data irrespective of the size of the data.

As is apparent from the foregoing description of the apparatus and method for transmitting mass data according to an embodiment of the present invention, since a data format is configured using a special character as a data delimiter, the capacity of transmission data can be minimized during mass data transmission between a client and a WAS, thereby maximizing the efficiency of mass data transmission.

Further, as data is segmented and the data segments are sequentially transmitted, memory use for data transmission in the WAS can be minimized, thereby maximizing the efficiency of mass data transmission.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for transmitting mass data, the method comprising:
receiving data transmission request information from a client, for data transmission by a transceiver of a Web Application Server (WAS);
determining a size of data requested by the client from a database storing the data based on the data transmission request information by a data checker of the WAS;
sequentially reading data of a predetermined size out of the whole data to be transmitted according to the size of the whole data and storing the read data in a memory of the WAS by a data extractor of the WAS;
sequentially converting the read data to a predetermined data format by a data converter of the WAS;
sequentially transmitting the converted data to the client by a transceiver of the WAS; and
deleting the completely transmitted data from the memory of the WAS by a data deleter of the WAS,
wherein at least one of American Standard Code for Information Interchange (ASCII) code decimal numbers 1 to 31 is used as a data delimiter in the data format.

2. The method according to claim 1, wherein the data format includes a plurality of records corresponding to the predetermined size, and the plurality of records and data included in the plurality of records are distinguished from each other by the data delimiter.

3. The method according to claim 2, wherein a unit separator being the ASCII code decimal number 31 is used as the data delimiter to distinguish data from each other in the same record in the data format.

4. The method according to claim 2, wherein a record separator being the ASCII code decimal number 30 is used as the data delimiter to distinguish records from each other in the same record in the data format.

5. An apparatus for transmitting mass data, the apparatus comprising:
a transceiver for transmitting and receiving data;
a memory for storing the data;
a data checker for determining a size of the data from a database storing the data based on data transmission request information received from a client by the transceiver;
a data extractor for sequentially reading data of a predetermined size out of the whole data to be transmitted according to the size of the whole data and storing the read data in the memory;
a data converter for sequentially converting the read data to a predetermined data format; and
a data deleter for, upon completion of transmission of the converted data, deleting the data from the memory,
wherein at least one of American Standard Code for Information Interchange (ASCII) code decimal numbers 1 to 31 is used as a data delimiter in the data format.

6. The apparatus according to claim 5, wherein the data format includes a plurality of records corresponding to the predetermined size, and the plurality of records and data included in the plurality of records are distinguished from each other by the data delimiter.

7. The apparatus according to claim 6, wherein a unit separator being the ASCII code decimal number 31 is used as the data delimiter to distinguish data from each other in the same record in the data format.

8. The apparatus according to claim 6, wherein a record separator being the ASCII code decimal number 30 is used as the data delimiter to distinguish records from each other in the same record in the data format.
